(19) United States
(12) Patent Application Publication
(10) Pub. No.: US 2007/0023336 A1
(43) Pub. Date: Feb. 1, 2007

(54) Inline filter monitoring device

(76) Inventor: Kevin M. Owens, Tampa, FL (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 11/194,385

(22) Filed: Aug. 1, 2005

(51) Int. Cl. B01D 35/14

(52) U.S. Cl. 210/130; 210/435; 210/433.1; 180/338; 180/339

(57) ABSTRACT

An inline serviceable filter has a rigid sleeve with inlet and outlet lines connected to end caps secured on opposing ends of the sleeve. The inlet and outlet conduits are easily secured in the transmission lines of a vehicle, for instance between a pump and a radiator, or a radiator and a transmission. Oil flows through a filter member positioned in the sleeve and is circulated in the transmission cooler lines. The filtering member can be cone-shaped and made from a material that is dense enough to stop large particles from passing through, yet not too dense to allow small particles to pass through. There is a bypass spring that redirects oil flow around the filter if the filter becomes clogged to prevent transmission meltdown. A monitoring window allows for monitoring the presence of particle buildup.

### BACKGROUND OF THE INVENTION

The present invention relates to a transmission filter for a vehicle, and more importantly to a serviceable Inline Transmission Filter.

In a transmission, oil flows from the pan through the hydraulic pump, into transmission's cooler system. The oil cools as it flows through the cooling system. The cooled oil then returns back into the transmission. The oil enters into the input and output shafts, lubricating the planetary gears from the inside out via sprinkler system. The oil then falls back into the pan.

Modern transmissions contain a Torque Converter with a “lock-up” clutch. The lock-up clutch forms a direct drive between the engine and input shaft of the transmission in order to halt the “slipping-effect” of the fluid coupling when the vehicle reaches a certain road speed.

Over time, the lining begins to peel away from the “lock-up” clutch. The material that peels away comes out of the converter, into the pan, through the hydraulic pump, and into the cooling system. The material clogs the cooler and prevents the oil from re-entering the transmission. Without lubrication from the oil, the planetary gear sets burn, causing major and costly damage.

Conventional transmission filters placed between the transmission and the cooling system are able to capture the debris. However, the filters become clogged over time and oil flow through the cooling system ceases. The planetary gear sets then perform without lubrication and burn.

The present invention contemplates provision of a device for monitoring buildup of debris coming from the torque converter/pump circulating field, thereby indicating when maintenance is needed for the torque converter, and preventing the meltdown of the transmission when its cooling system becomes clogged.

### SUMMARY OF THE INVENTION

It is, therefore, an object of the present invention to provide an inline filter placed between the transmission and the cooler that can be monitored and serviced periodically to prevent transmission problems and prevent cooler blockage.

It is a further object of the present invention to provide a means for preventing fluid blockage if the inline filter becomes clogged.

It is a further object of the present invention to provide an inline filter device that can also be placed downstream of the cooler to catch debris dislodged from the cooler.

These and other objects of the present invention are achieved through a provision of a filter device adapted for positioning in a transmission cooler line of a vehicle. The filter device has a rigid sleeve formed from a non-corrosive material. An end cap is engaged with each of the sleeve, and a fluid conduit line is attached to a respective end cap.

A mesh filter member is positioned in the sleeve, the filter member has an upstream end secured to the inlet conduit. A fitting member is positioned in the downstream end of the sleeve, the fitting member is fluidly connected to the outlet line. A bypass spring is fitted between the filter member and the fitting member, normally urging the filter member away from the fitting member to prevent clogging of the filter device.

The fitting member has a connector with a plurality of apertures, through which fluid exiting the filter passes on the way towards the outlet line. A transparent or translucent window formed in the sleeve allows monitoring of the filter condition and detection of undesirable debris accumulation in the transmission cooler line.

### BRIEF DESCRIPTION OF THE DRAWINGS

Reference will now be made to the drawings, wherein like parts are designated by like numerals, and wherein

FIG. 1 is a cross-sectional view of the filter device in accordance with the present invention.

FIG. 2 is an exploded view of the filter device of the present invention.

FIG. 3 is a detail view of the filter member of the device of the present invention.

FIG. 4 is a schematic view illustrating position of the filter device in the transmission cooling line.

FIG. 5 is a detail view illustrating connection of a downstream end of a filter member with an inlet conduit.

### DETAIL DESCRIPTION OF THE PREFERRED EMBODIMENT

Turning now to the drawings in more detail, the transmission filter of the present invention is generally designated by numeral 10. The filter structure 10 has a rigid outer sleeve 12, which may be constructed from a rust-resistant, hard material, such as metal. An inlet conduit 14 extends outside from the upstream end 16 of the sleeve 12. An outlet conduit 18 extends from the downstream end 20 of the sleeve 12.

The conduits 14 and 18 has a means 15 and 19, respectively, to allow the conduits 14 and 18 to be fluidly connected within a transmission cooling line in a pre-determined location, for instance a line 22 extending between a pump 24 and a radiator 26. As can be seen in FIG. 4, the pump 24 is fluidly connected with a transmission 28, which is in turn engaged with a torque converter 30 and an engine 32. The filter device 10A is adapted for filtering debris that entered the cooling line 22 from the torque converter. A similar filter device 10B may be positioned in a radiator cooling line 36 to catch debris from the cooler.

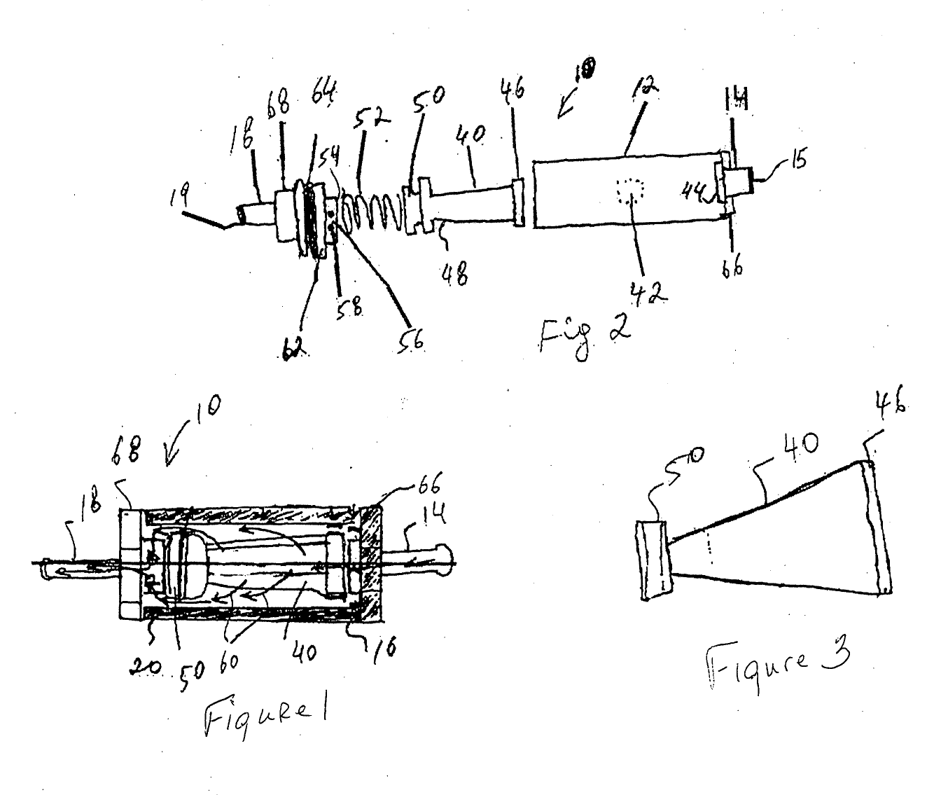

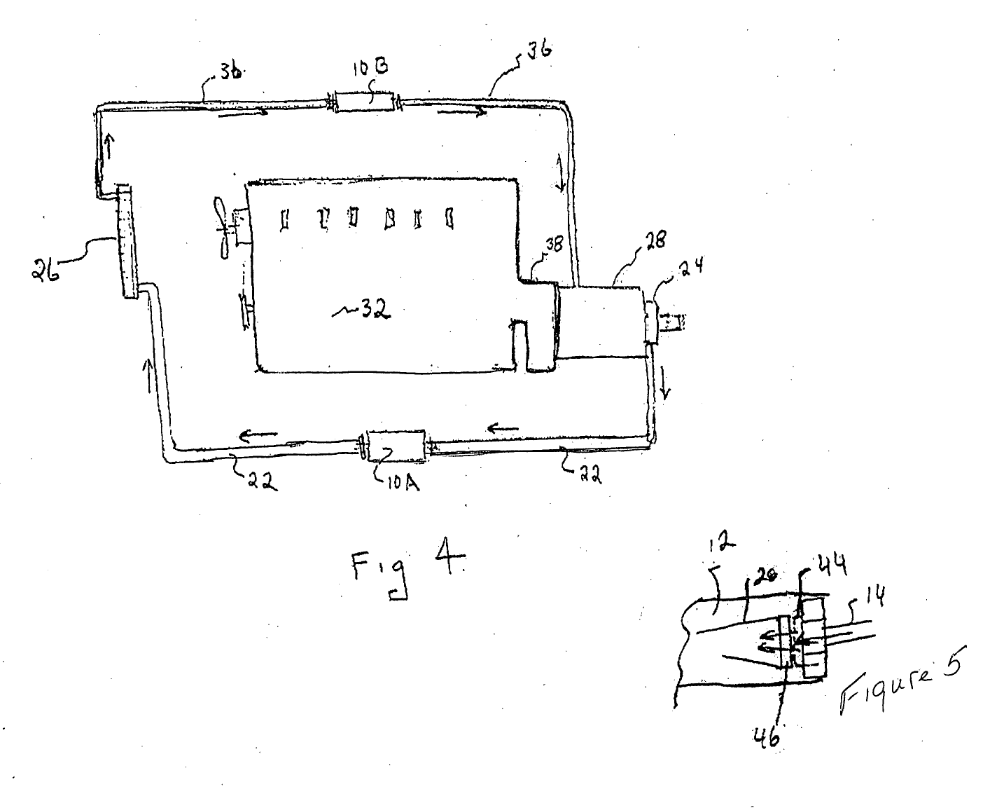

The filter device 10 further comprises a filter member 40, which has a mesh body, allowing liquid to pass through the mesh openings, while capturing solid particles larger than the mesh openings. The filter body may be formed in a conical shape, as shown in FIGS. 1 and 2 or may have a cylindrical shape, if desired. A transparent window 42 can be made in the sleeve 12 to allow monitoring of solid buildup on the filter member 40.

The inlet conduit 14 has an inner part 44, which extends in the interior of the sleeve 12. The filter member 40 has an annular locking flange 46, which is sized and shaped to engage the inner part 44 and lock therewith, thereby securing the filter member 40 in the sleeve 12. A downstream end 48 of the filter 40 has an annular lip 50 that forms an abutting surface for a bypass compression spring 52. The bypass spring 52 redirects oil flow around the filter member 40 if the filter becomes clogged to prevent transmission meltdown. An opposite end of the bypass spring 52 urges against an abutting surface 54 of a connecting member 56.

The connecting member 56 has a plurality of apertures 58 formed in the wall thereof. The openings 58 communicate with a central opening (not shown) of the connecting member 56. The fluid exiting from the filter member 40 flows inside the sleeve 12 along fluid paths schematically designated by arrows 60 in FIG. 1. The fluid then enters the connecting member 56 through the apertures 58 and moves into the outlet line 18.

The connecting member 56 is unitary connected to a fitting 62, which has a groove 64 for receiving an O-ring 64 therein. The O-ring 64 seals the fitting member 62 against the interior wall of the sleeve 12 in the outlet area and prevents escape of fluids around the fitting member 62. The fitting 62 is securely engaged with the outlet conduit 18. The sleeve 12 is provided with a pair of end caps 66, 68, which close the inlet end 16 and the outlet end 20, respectively of the sleeve 12.

The end caps 16 and 20 carry the conduits 14 and 18, respectively. The end caps 66, 68 are detachably threadably engageable with the respective ends of the sleeve 12 and can be removed or tightened with a suitable tool, for instance a wrench. When one or two end caps are removed, the user may remove the filter member 40, if desired and position another, clean filter in the sleeve 12 and reinsert the filter device 10 in the transmission line.

The filter member 40 preferably has mesh openings that are fine enough to catch large debris but not too fine to let small debris go through so as to prevent premature clogging. The device 10 can be periodically inspected to monitor condition of the filter member 40 and thereby monitor possible debris accumulation in the transmission lines. Considering that the main culprit of the cooler being clogged up is the converter 30 with a lock-up clutch, the filter device of the present invention, when strategically positioned in the transmission cooling lines, minimizes or even eliminates the danger of transmission breakage and cooler blockage. The monitored filter device 10 helps prevent buildup which clogs filters and causes transmission meltdowns. The device 10 can be placed before and after pump 24.

In a normally functioning transmission, no debris should be floating in the cooling lines. However, because lockup converters have a clutch lining in them that tends to peel off after a period of time. When it peels off, it comes out of the converter neck and enters the front pump and right into the gears. The solid particles are then forced out of the cooler line because the cooler line taps the passage from the pump. The debris then enters a purser regulator on the valve body, but most of the material that comes off of the lock up clutch lining comes out of the converter, goes into the pump and goes right out of the exit cooler line from the transmission and goes right into the cooler and stops it up. The instant invention eliminates this problem by allowing to capture the debris before it clogs the cooler lines, thereby substantially extending the life of a transmission.

When the filter 10 is checked on a regular basis and the user observes that some converter clutch material begins to accumulate in the filter or debris is going through it, then the user can check the filter 10 in the next couple of months and should more debris is detected, then the user will know that the converter may have a potential problem. The user may then elect to change the converter 39 and save it from burning up in the near future.

I claim:

1. A filter device for monitoring condition of a transmission cooler line in a vehicle, the filter device comprising:
a hollow sleeve having an inlet conduit and an outlet conduit connected to opposing ends of the sleeve and configured for positioning in the transmission cooler line;
a liquid permeable filter member positioned in the sleeve in fluid communication with the inlet conduit;
a fitting member positioned in the sleeve downstream from said filter member, said fitting member providing fluid communication between interior of the sleeve and the outlet conduit; and
a bypass compression spring mounted between the fitting member and the filter member, said bypass spring normally urging the filter member away from the fitting member to prevent clogging of the sleeve with solid particles passing through the transmission cooler lines.

2. The device of claim 1, wherein said inlet conduit has an interior portion positioned in an upstream end of the sleeve, and wherein a first end of the filter member is sized and shaped to engage with said interior portion.

3. The device of claim 2, wherein said filter member has a second end, and wherein an annular lip is formed on the second end.

4. The device of claim 3, wherein one end of the bypass spring urges against said annular lip of the filter member.

5. The device of claim 1, wherein said inlet conduit and said outlet conduit are provided with means for securing the filter device in the transmission cooler line.

6. The device of claim 1, wherein said sleeve carries an end cap on each of the opposing ends, and wherein the inlet conduit and the outlet conduit is connected to a respective end cap.

7. The device of claim 1, wherein said fitting member comprises a connecting member having a plurality of apertures formed about circumference thereof, said apertures communicating with interior of the sleeve and the outlet conduit.

6. The device of claim 1, wherein said fitting member is provided with a groove, and wherein and O-ring is positioned in the groove to seal the fitting member against interior of the sleeve.

8. The device of claim 1, wherein said filter member has an exterior diameter at least slightly smaller than an interior diameter of the sleeve.

9. The device of claim 1, wherein said filter member has a generally conical configuration.

10. The device of claim 1, wherein said sleeve is provided with a transparent window to allow visual monitoring of the filter condition.

11. A filter device for monitoring condition of a transmission cooler line in a vehicle, the filter device comprising:
a hollow sleeve having an inlet conduit and an outlet conduit connected to end caps carried by opposing ends of the sleeve, said inlet conduit and said outlet conduit being provided with a means for securing the sleeve in the transmission cooler line;
a liquid permeable filter member positioned in the sleeve in fluid communication with the inlet conduit, said filter member having a mesh body and an annular lip secured on a downstream end of the filter member;
a fitting member positioned in the sleeve downstream from said filter member, said fitting member providing fluid communication between interior of the sleeve and the outlet conduit; and
a bypass compression spring mounted between the fitting member and the filter member, said bypass spring normally urging the filter member away from the fitting member to prevent clogging of the sleeve with solid particles passing through the transmission cooler lines.

12. The device of claim 11, wherein one end of the bypass spring urges against the annular lip of the filter member.

13. The device of claim 11, wherein said filter member has an annular flange on an upstream end, said annular flange being sized and shaped for engaging the inlet conduit.

14. The device of claim 11, wherein said fitting member comprises a connecting member having a plurality of apertures formed about circumference thereof, said apertures communicating with interior of the sleeve and the outlet conduit.

15. The device of claim 11, wherein said fitting member is provided with a groove, and wherein and O-ring is positioned in the groove to seal the fitting member against interior of the sleeve.

16. The device of claim 11 wherein said filter member has an exterior diameter at least slightly smaller than an interior diameter of the sleeve.

17. The device of claim 11, wherein said sleeve is provided with a transparent window to allow visual monitoring of the filter condition.
